(19) United States
(12) Patent Application Publication
(10) Pub. No.: US 2011/0214333 A1
(43) Pub. Date: Sep. 8, 2011

(54) Fishing Lure

(76) Inventor: Clemente Travieso, Lake Clarke Shores, FL (US)

(21) Appl. No.: 12/717,323

(22) Filed: Mar. 4, 2010

(51) Int. Cl. A01K 85/00

(52) U.S. Cl. 43/42.39; 43/42.28

(57) ABSTRACT

A bottom fishing lure having a lure body and a hook. The lure body includes a head portion and tail portion. The tail portion has a hook attached thereto. The hook includes a shank secured to the tail portion of the lure and a hook end. An eyelet is secured to the head portion of the lure and provides a point at which a fishing line can be secured to the lure. A center axis extends along the length of the lure and a plane extends along the center axis. The head portion of the lure contains a substantial mass or weight and is positioned below the plane extending along the center axis. This positions the hook above the bottom of a body of water and prevents the hook from snagging any objects on the bottom.

### FIELD OF THE INVENTION

This invention relates generally to fishing lures and, more particularly, to a fishing lure having a specific weight distribution and construction to prevent entanglement of the fishing lure on an object or on the bottom surface of a body of water.

### BACKGROUND OF THE INVENTION

Fish tend to congregate along specific oceanographic features and bottom topography. This is mainly because the food and bait fish that they feed on are found in these areas. Fishermen have developed a wide range of fishing methods to secure their catch. By selecting the right fishing method for the right environment, fishermen are sure to maximize their efforts. For instance, purse seining establishes a large wall of netting to encircle schools of fish. The fish are caught by the fisherman pulling the bottom of the netting closed. Another fishing method example is gill netting. Gill netting uses curtains of netting that are suspended between floats and weights that enable the netting to span almost the entire depth of the body of water thereby insuring that the fish will swim into the netting. Yet another fishing method example is trawling. In trawling, nets are dragged along the sea floor or midway between the floor and surface to catch fish or shellfish therein. These methods are primarily employed by commercial fishermen.

Individual sport fishermen employ different techniques. The most popular technique involves drawing a fishing lure through the water at various different depths. These different depths depend on the type of fish being sought. One technique involves drawing a fishing lure along the bottom of a body of water. Many fish find food along the bottom of these bodies of water and tend to become bottom feeders. To catch these fish, the fisherman must present the lure in an appealing manner along the bottom of a body of water. One of the main problems associated with this type of fishing is the fish biting or “taking” the hook when they bite the bait. If the hook is not positioned correctly on the bait there is a problem that the fish will not “take” the hook on the first bite and will not return to the lure. Another problem associated with many fishing lures is the propensity of the fishing lure to become entangled with the bottom surface and/or objects on the bottom surface such as rocks and wood structure as the fishing lure is dragged along the bottom surface. In most instances the hook engages the object and becomes securely attached to the object. When this happens, it is very difficult to extract the lure and frequently requires the fisherman to cut the line, thereby losing the lure.

Another popular technique is to cast the lure onto the surface of a body of water and allow the lure to settle to the bottom, and then retrieve the lure by applying force on the fishing line, by the movement of the boat or reeling of the fishing pole, to move the lure upwardly off the bottom and in the direction towards the fisherman. This action is repeated frequently in succession so as to simulate the action of prey that would likely attract a bottom predator. However, when the lure settles to the bottom there is an increased possibility of the lure being entangled with the bottom of the body of water or objects resting on the bottom floor.

### PRIOR ART

U.S. Pat. No. 4,450,645 discloses a bottom fishing lure consisting of a fishhook having a weighted, non-buoyant head adapted to be pulled head first along the bottom surface of a body of water by a fishing line. The fishing lure is supported by the hook and a pair of resilient legs extending from a head portion of the lure. The disadvantage associated with this fishing lure is the hook is susceptible to being entangled with weeds, debris, or the like along the bottom surface due to the bight portion of the hook being drawn along the bottom surface. What is desired is a fishing lure capable of being drawn along the bottom surface of a body of water without the hook resting thereon.

The need to have the hook suspended above the bottom floor was recognized by U.S. Pat. No. 5,930,941 to reduce the likelihood of the lure being entangled with the bottom surface or bottom objects. U.S. Pat. No. 5,930,941 discloses a fishing lure, capable of being drawn through a body of water by fishing line, having a body with the shank of a hook extending from the rearward end of the body. The pointed end of the hook extends towards the body. The eyelet of the hook is secured to the body adjacent the forward end of the body to receive a fishing line. A pair of deflectable arms is secured to the body and extends downwardly and rearwardly from the body. The distal ends of the arms and the forward end of the body, having a nose, form three triangularly positioned support points that support the lure body if the lure contacts the bottom surface of a body of water. The shank of the hook extends upwardly at an angle with respect to the horizontal (bottom surface of a body of water) of about 30° to 60°. The problems associated therewith is the possibility of entanglement of the bottom surface or bottom objects with the distal ends of the pair of arms resting along the bottom surface as the fishing lure is dragged along. Furthermore, although the body of the fishing lure is weighted, the distribution of weight is not disclosed. It would be advantageous to provide a lure body having a weight distribution which is substantially heavier at the point which the lure body contacts the bottom surface to keep the hook suspended from the bottom surface.

While these prior arts may be suitable for the particular purpose to which they address, these prior arts would not be suitable for the purposes of the present invention as heretofore described. As a consequence of these aforementioned problems, it is an objective of the present invention to provide a fishing lure having a fishing hook suspended away from the bottom surface of a body of water and using a weight distribution on the nose portion of the lure body to thereby substantially reduce the possibility of the fishing lure being entangled with objects on the bottom surface.

### SUMMARY OF THE INVENTION

A bottom fishing lure having a lure body and a hook. The lure body includes a head portion and tail portion. The tail portion has a hook attached thereto. The hook includes a shank secured to the tail portion of the lure and a hook end. An eyelet is secured to the head portion of the lure and provides a point at which a fishing line can be secured to the lure. A center axis extends along the length of the lure and a plane extends along the center axis. The head portion of the lure contains a substantial mass or weight and is positioned below the plane extending along the center axis. This positions the hook above the bottom of a body of water and prevents the hook from snagging any objects on the bottom.

Accordingly, it is an objective of the present invention to provide a fishing lure which can readily move and present the hook to the fish thus resulting in an increased hook up ratio.

Accordingly, it is another objective of the present invention to provide a fishing lure which in its operative position positions a hook above the bottom surface to reduce the possibility of entanglement with the bottom surface or bottom object in a body of water.

It is a further objective of the present invention to provide a fishing lure which replicates the movement, vibration, and color of prey.

It is yet another objective of the present invention to provide a fishing lure with only one point of contact, to substantially reduce the possibility of entanglement with the bottom surface of a body of water.

It is a still further objective of the present invention having a hook positioned and arranged to better engage a fish's mouth and minimize any fouling by bottom objects or the bottom surface.

It is yet still another objective of the present invention to provide a fishing lure having a specific gravity heavier than that of water to enable the lure to remain on the bottom of a body of water.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a top perspective view of one embodiment of the fishing lure of the present invention;

FIG. 2 is a top perspective view of another embodiment the present invention;

FIG. 3 is a left side view of the present invention;

FIG. 4 is a right side view of the present invention;

FIG. 5 is front view of the embodiment of FIG. 1;

FIG. 6 is a front view of the embodiment of FIG. 2; and

FIG. 7 is a schematic representation of the present invention.

### DETAILED DESCRIPTION OF THE INVENTION

Although the invention will be described in terms of a specific embodiment, it will be readily apparent to those skilled in this art that various modifications, rearrangements and substitutions can be made without departing from the spirit of the invention. The scope of the invention is defined by the claims appended hereto.

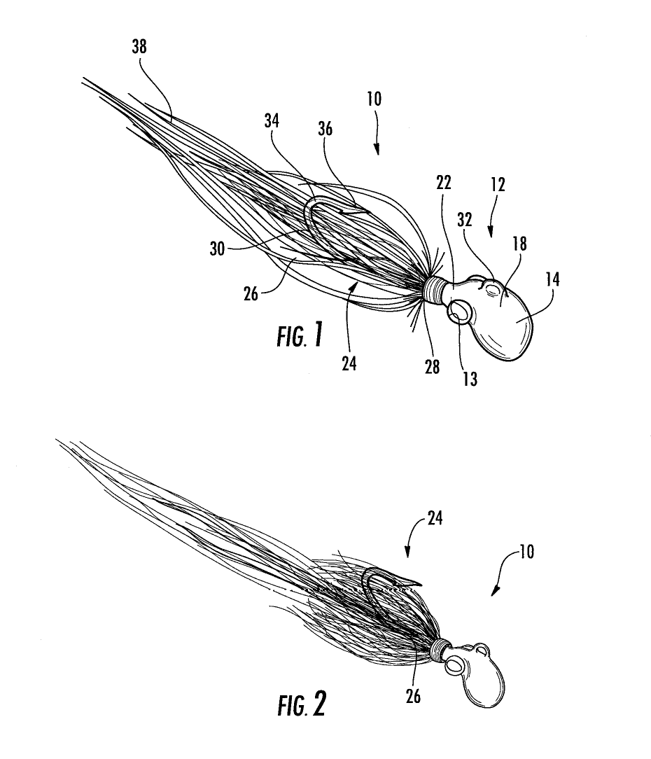

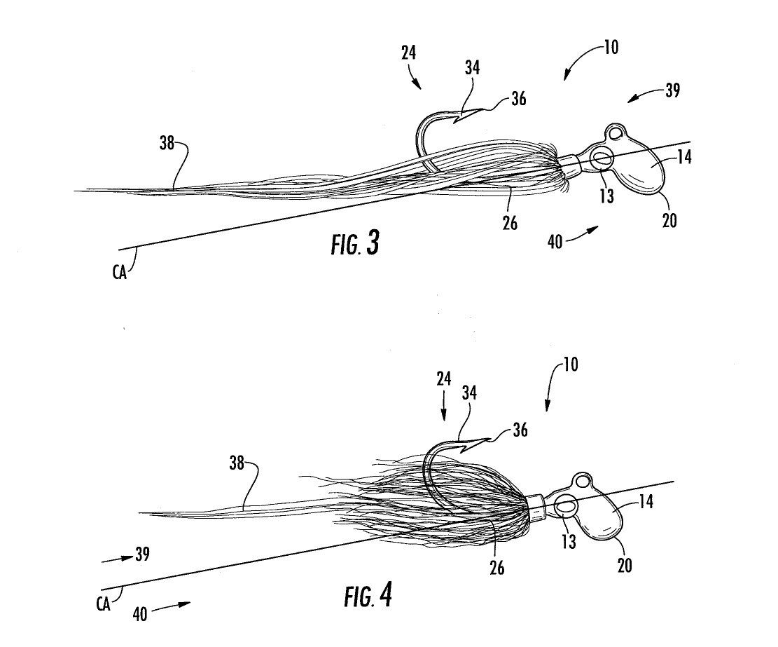

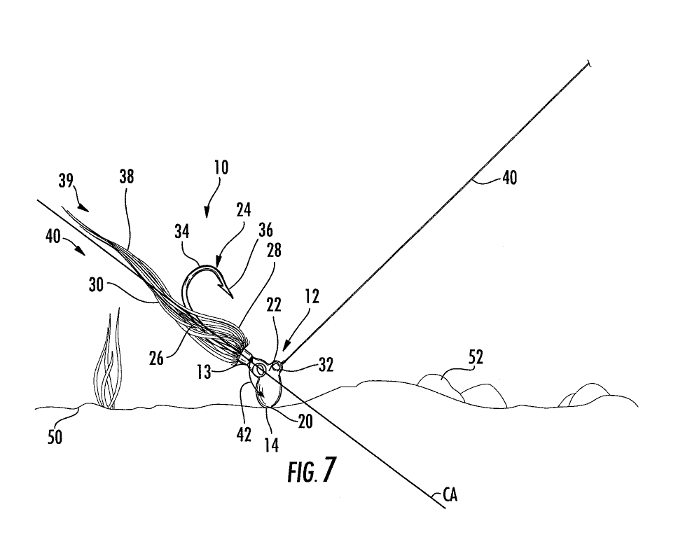

Now referring to FIGS. 1-7, the fishing lure of the present invention will now be described. The fishing lure 10 has a lure body 12 having a head portion 14 and a tail portion 22. The lure body 12 is configured to simulate the prey of the fish or marine life being fished for. The lure body can be made in various different colors which simulate the prey of the fish or attract the fish. The tail portion 22 of the lure body 12 is of a substantially cylindrical shape. The lure body 12 may include a set of eyes 13 thereon to replicate the appearance of prey. Preferably there is one eye on each side of the lure body adjacent the head portion. The head portion 14 and tail portion 22 intersect to form the lure body 12. The tail portion 22 has a hook 24 secured thereto. The hook 24 is preferably integrally formed with the tail portion 22. The hook 24 includes a shank 26 and a hook end 34 secured to one end of the shank. The opposite end of the shank is secured to the tail portion 22 of the lure body 12.

A longitudinal axis CA extends along the length of the fishing lure 10 (FIGS. 3, 4 and 7). The longitudinal axis CA extends from the head portion 14 of the body along the tail portion 22 and along the shank 26 of the hook. A plane extends along and is parallel to the longitudinal axis CA. The plane extends into the page in FIGS. 3, 4 and 7 thereby defining an area 39 above the plane and an area 40 below the plane. A substantial portion of the head 14 portion of the body is positioned in area 40 below the plane, as seen in FIGS. 3, 4 and 7. The hook end 34 is positioned in area 39 above the plane, as seen in FIGS. 3, 4 and 7. The portion of the head positioned below the plane has a large mass or weight, relative to the size of the entire lure, to position the lure such that the hook end 34 of the hook is in an upright position and will not engage or touch the bottom surface of a body of water, as seen in FIG. 7.

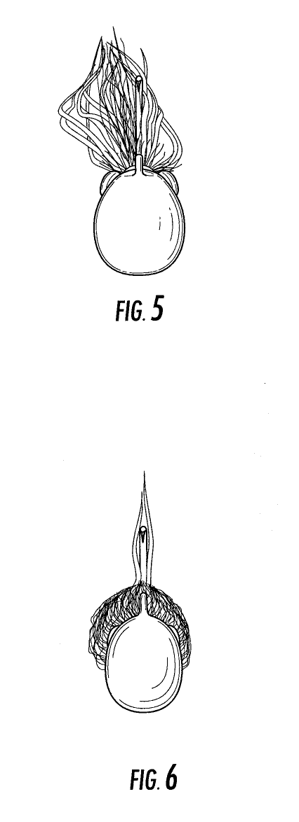

The shank 26 of the hook has a proximal end 30 and distal end 28. The distal end 28 of the hook 24 is secured to the tail portion 22 of the lure body 12. The proximal end 30 of the hook 24 has a hook end 34 terminating in a pointed end 36. The hook end 34 is positioned above the plane which extends along center axis CA. The pointed end 36 extends towards the head portion of the lure. An eyelet 32 is positioned on the head portion of the body above the plane. The eyelet 32 is preferably perpendicular to the plane which extends along center axis CA. The eyelet 32 allows for the attachment of a fishing line 40 thereto. The tail portion 22 of the body also includes a plurality of flexible resilient strand members 38 which are secured to and extend rearwardly from the tail portion 22 of the lure body 12 in the direction of the hook 24. In one embodiment the strand members 38 extend beyond the hook end 34 of the hook 24, FIG. 3. In another embodiment strand members 38 have at least two different lengths. A first length extends proximate the end of hook portion 34 of the hook and a second length extends rearwardly substantially beyond the hook end 34, FIG. 4. The strand members 38 can be all the same shape and color. Alternatively, the strand members 38 can have various shapes, can have various cross sectional areas and can be made in various colors. The various shapes and colors of the strand members 38 are selected to simulate prey of various fish. Accordingly, different lures having different strand member lengths and colors are selected depending on the type of fish that is being caught. The shank 26 of the hook 24 may be of varying lengths depending on the intended use of the fishing lure 10 as large prey may require a larger shank 26. It is also contemplated that the shank 26 may be curved. Furthermore, the hook end 34 may also be of varying size for similar reasons.

The head portion 14 of the lure body 12 is preferably positioned below the plane extending along center axis CA at an obtuse angle 42 to the center axis CA, FIG. 7. The head portion 14 is made from a material having a specific gravity heavier than water so as to sink when placed in water. The head portion 14 is made from a metal, a metal alloy or preferably lead. The head portion can also be made from other materials having a specific gravity greater than water. The head portion 14 comprises a mass of lead or other heavy metal molded thereabout. This is a feature of so-called “lead-head” jigs, and is common in the art. When the fishing lure 10 sinks to the bottom surface 50 of a body of water, the head portion 14 maintains contact with the bottom surface 50 pulled by the fishing line 40. The concentration of mass in the head portion 14 below the center axis CA creates a fulcrum point or point of contact 20 with the bottom surface. The fulcrum point 20 on the head portion 14 and tension on the line 40 permits the hook 24 to remain positioned above the bottom surface 50 of the body of water. The head portion 14 preferably has an oval shape. However, other geometrical shapes are contemplated. Furthermore, depending on the geometrical shape of the head portion 14, the fulcrum point may have varying surface areas.

The fulcrum 20 allows the lure to readily pivot or rotate when the lure is on the bottom surface of a body of water. This is especially useful for increasing the hook up ratio of the lure. The hook up ratio prior to the present invention was typically 40%-60%. The hook up ratio is the ratio of the number of times a fish is hooked by the lure compared to the number of times the fish bites at the lure. It has been discovered that whenever a fish opens their mouth to eat or bite at a lure, a suction is created. The combination of the strand members 38 in the tail portion 22, the fulcrum 20 and the suction produced by the fish allow the lure to pivot or rotate so that the hook is positioned toward the fish when the opens their mouth to take the lure. The size and shape of the strand members 38 can be selected based on the species of fish that an angler is going after to allow the lure to more readily pivot or rotate.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A fishing lure comprising:
a jig having a body, said body including a head portion and a tail portion, said body having a longitudinal axis extending therethrough;
a hook, said hook including a shank and a hook end, said shank being integrally formed with said tail portion of said body;
said longitudinal axis extending along said shank of said hook;
a plane extending along said longitudinal axis;
said hook end of said hook extending above said plane;
an eyelet secured to said head portion for securing a line thereto, said eyelet extending above said plane;
said jig having a specific gravity heavier that water so that said jig tends to sink in a body of water;
a substantial portion of said body extending below said plane;
said head portion of said body is substantially larger that said tail portion of said body and includes a substantially greater portion of said weight of said jig,
whereby said fishing lure sinks to a bottom of a body of water and is supported in a position wherein said head portion of said body engages a bottom of a body of water and said hook end extends upwardly and away from said bottom of said body of water thereby preventing said hook end from contacting said bottom or objects located on said bottom.

2. The fishing lure of claim 1, wherein said tail portion includes a plurality of flexible strand members secured thereto and extending rearwardly toward said hook end, said flexible strand members simulating marine life.

3. The fishing lure of claim 2, wherein said flexible strand members have at least two different lengths, each of said lengths extending at least from said tail portion of said body to past said hook end of said hook.

4. The fishing lure of claim 1 including a plurality of eyes on said head portion of said body.

5. The fishing lure of claim 1, wherein said lure body is configured to simulate marine life.

6. The fishing lure of claim 1, wherein the pointed end of said hook end extends toward said eyelet.

7. The fishing lure of claim 1, wherein said head portion is made of a metal alloy.

8. The fishing lure of claim 1, wherein said head portion is made of lead.

9. The fishing lure of claim 1, wherein said eyelet is substantially perpendicular to said center axis.

10. The fishing lure of claim 1, wherein said flexible strand members have different cross sectional shapes.

11. The fishing lure of claim 1, wherein said flexible strand members are different colors.

12. The fishing lure of claim 2 wherein the flexible strands and jig are constructed and arranged to permit said fishing lure to pivot said hook toward a fish when the fish bites at the lure.
